(19) United States
(12) Patent Application Publication
(10) Pub. No.: US 2005/0032555 A1
(43) Pub. Date: Feb. 10, 2005

(54) Method of intermittent activation of receiving circuitry of a mobile user terminal

(76) Inventors: Iqbal Jami, Swindon (GB); Mazlyn Mona Mustapha, Swindon (GB)

Correspondence Address: Docket Administrator (Room 3J-219);Lucent Technonlogies Inc., 101 Crawfords Corner Road, Holmdel, NJ, 07733-3030, US

(21) Appl. No.: 10/637,995

(22) Filed: Aug. 7, 2003

(51) Int. Cl. H04Q 7/20

(52) U.S. Cl. 455/574; 455/458; 455/343.4

(57) ABSTRACT

A method is provided of intermittent activation of receiving circuitry of a mobile user terminal so as to listen to a paging channel. The activation is periodic. The period is selected dependent upon either the time of day or which of a plurality of types of service is provided in the last call connection to the mobile user terminal.

### FIELD OF THE INVENTION

The present invention relates to telecommunications, and more particularly to a method of wireless communication.

### BACKGROUND OF THE INVENTION

In known networks for mobile telecommunications, the time intervals between a mobile user terminal “waking up” so as to start to listen to a paging channel are of constant length.

### SUMMARY OF THE INVENTION

In an embodiment of the present invention, a method of intermittent activation of receiving circuitry of a mobile user terminal is provided to listen to a paging channel. The activation may be periodic. The period may be selected dependent upon either the time of day or which of a plurality of types of service may be provided in the last call connection to the mobile user terminal. Another example is a corresponding network for mobile telecommunications.

Some embodiments of the present invention may have the period, also known as discontinuous reception cycle length, adjusted dependent upon the type of service required. The period may be shorter where, for example, the call connection is in respect of a service requiring a fast response, such as an ‘interactive' service, as compared to where the call connection is in respect of a service needing only a slow response, such as a ‘background’ service. This has the advantage that a mobile user terminal that requires a ‘background’ service, avoids wasting precious battery power by listening to the paging channel more often than it needs to.

Some embodiments may have another period, in particular a Core Network (“CN”) discontinuous reception cycle length, which may be set dependent upon on the time of day. The time of day may be a guide to expected traffic activity. For example, users may be more likely to receive calls during the daytime rather than in the early hours of the morning, so the period may be selected to be shorter in the daytime. This leads to more efficient use of the energy in the mobile user terminal's battery since the mobile user terminal may not wake up so often to listen to the paging channel if the likelihood of an incoming call is relatively low.

### BRIEF DESCRIPTION OF THE DRAWINGS

The present invention will be better understood from reading the following description of non-limiting embodiments, with reference to the attached drawings, wherein below:

FIG. 1 is a diagram illustrating a UMTS network;

FIG. 2 is a diagram illustrating a mobile user terminal;

FIG. 3 is a diagram illustrating mobile user terminal On/Off periods for reception of messages on a paging channel;

FIG. 4 is a diagram illustrating the effect of discontinuous reception cycle length on the timing of sending a paging message to a mobile user terminal;

FIG. 5 is a diagram illustrating as functional blocks part of the operation of radio network controller (RNC) shown in FIG. 1;

FIG. 6 is a flow chart illustrating selection of a UTRAN discontinuous reception cycle length dependent upon call service type; and

FIG. 7 is a diagram illustrating as functional blocks part of the core network shown in FIG. 1.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

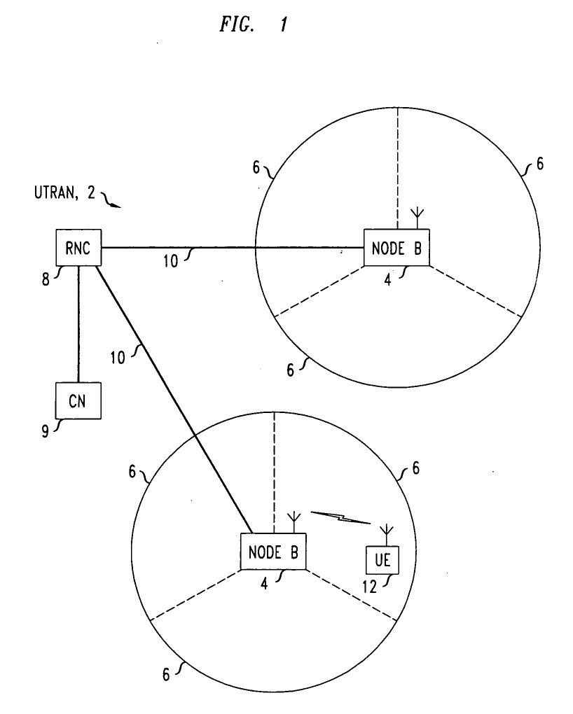

One wireless communications network is a Universal Mobile Telecommunications System (“UMTS”) terrestrial access network (“UTRAN”), which is a type of wideband code division multiple access (“CDMA”) network for mobile telecommunications. An exemplary UTRAN network is shown in FIG. 1. Only one radio network controller and two base stations of the UTRAN network 2 are shown for simplicity. As shown in this Figure, the UTRAN network 2 includes base stations 4. Each base station (Node B in UMTS terminology) 4 typically has three cells 6 (e.g., radio coverage areas, also known as sectors) as the base station 4 typically has three directional antennas (not shown) angled at 120 degrees to each other in azimuth. Radio network controllers (RNC) 8 which are themselves connected to the rest of the telecommunications “world” (denoted Core Network CN 9) each control several base stations 4 and hence a number of cells 6. A base station 4 is connected to its controlling radio network controller (RNC) 8 via a respective interface 10 known as an IuB interface. In use, a mobile user terminal 12 (often referred to as User Equipment (UE) in UMTS terminology) communicates with a serving radio network controller (RNC) 8 via at least one cell 6 of at least one base station 4 (e.g., communicates with the UTRAN network 2).

Discontinuous Reception (Discontinuous Reception) to Save Battery Power

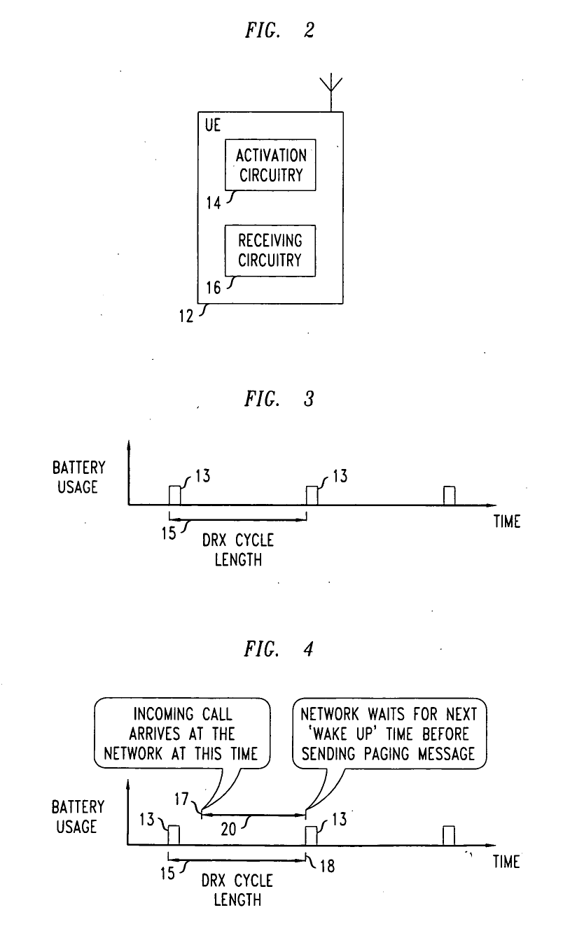

When a mobile user terminal is not actively sending or receiving data (e.g., not in a call connection), it may listen for any call connection requests coming in on a paging channel. As shown in FIGS. 2 and 3, in order to save the energy stored in the battery of the mobile user terminal, the mobile user terminal listens to the paging channel, by activation circuitry 14 activating its receiving circuitry 16, only at pre-determined intervals 13. This is known as discontinuous reception (sometimes denoted DRX). The mobile user terminal may not listen continuously to the paging channel if not involved in a call, thereby conserving battery power. The interval 15 between the starts of consecutive intervals of listening to the paging channel is called the discontinuous reception cycle length.

As shown in FIG. 4, if there is a call for a particular mobile user terminal arriving at the radio network controller (RNC) 8 at a particular time 17 then the RNC, the radio network controller (RNC) 8 may ensure that the paging message for the particular mobile user terminal is transmitted at the time 18 when the mobile user terminal is listening to the paging channel—e.g., during one of the awake periods 13. There is thus a delay 20.

It will be understood that the longer the discontinuous reception cycle length, the longer time it is likely to take to establish the call. However, in this case the battery life of the mobile user terminal before a recharge is required is extended. On the other hand, if a shorter discontinuous reception cycle length is used, the time taken to establish the call may be reduced, but the battery life may be shortened as a consequence.

In the UMTS network 2, two discontinuous reception cycles are defined namely at UTRAN level and at core network level. These are considered in turn below.

Setting UTRAN Discontinuous Reception Cycle Length

The UTRAN discontinuous reception cycle length may be selected to be different for different mobile user terminals and its value may be signalled to the mobile user terminal by the UMTS network 2 whenever a control-signalling connection to the mobile user terminal exists. This discontinuous reception cycle may be applied if the mobile user terminal has a signalling connection to the UMTS network 2, but may not be actively sending or receiving user data, in other words the mobile user terminal is in UTRAN Registration Area—Paging Channel mode (which is often denoted URA_PCH mode).

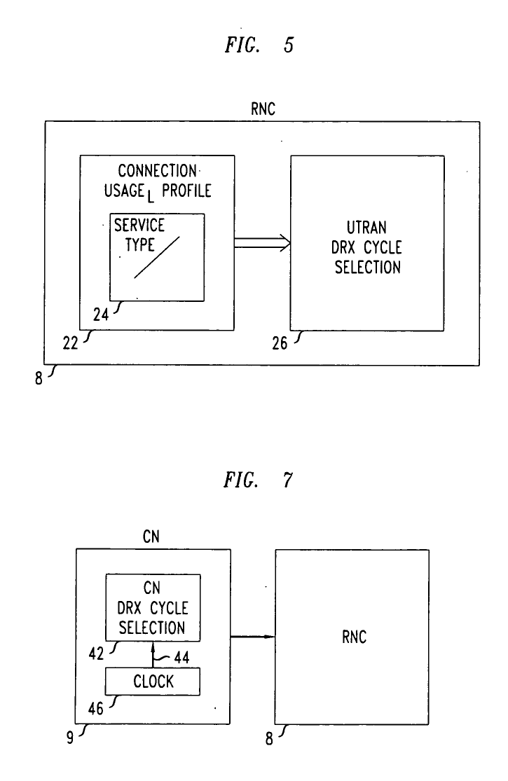

As shown in FIG. 5, the UTRAN discontinuous reception cycle length for a particular mobile user terminal may be set depending on the type of service of the last call to that the particular mobile user terminal. This may be because of an expectation that the next call is most likely to be of the same type. For example, for services requiring a fast response time such as an ‘interactive’ type of service (e.g., on-line gaming or web browsing), the UTRAN discontinuous reception cycle length may be set to a shorter value than if the type of service does not require a fast response time—e.g., background services such as transferring files or downloading email.

As shown in FIG. 5, the UTRAN discontinuous reception cycle may be set by the radio network controller (RNC) 8. The RNC 8 receives a user connection profile 22 associated with a call to be set up which includes an indication 24 of the type of service the call connection to the mobile user terminal is used for. The indication 24 may be used by the UTRAN discontinuous reception cycle selector 26 in selecting the UTRAN discontinuous reception cycle length to be transmitted to the mobile user terminal 12.

The information of UTRAN discontinuous reception cycle length may be transmitted to the particular mobile user terminal as part of the dedicated control-signalling involved in setting up the call to that mobile user terminal. Once the call has finished, the mobile user terminal thereafter uses the selected UTRAN discontinuous reception cycle length it has been informed of, at least until a new call to the mobile user terminal in respect of a different type of service may cause a fresh UTRAN discontinuous reception cycle length to be selected.

Setting the UTRAN discontinuous reception cycle length depending on service type may saves energy in the mobile user terminal's battery whilst providing an appropriate response time for the most likely next expected service.

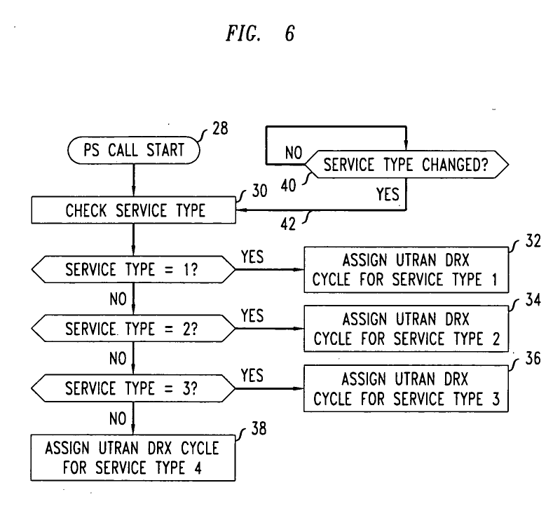

The UTRAN discontinuous reception cycle length may be set as part of a packet switched call. As shown in FIG. 6, once the packet switched (“PS”) call is requested, the radio network controller (“RNC”) may select a discontinuous reception cycle length appropriate for the type of packet switched service requested. For example, as shown in FIG. 5, after the start of a packet switched call 28, service type may be determined 30. If of a first service, a first UTRAN discontinuous reception cycle length may be assigned 32. Else if of a second service, a second UTRAN discontinuous reception cycle length may be assigned 34. Else if of a third service, a third UTRAN discontinuous reception cycle length is assigned 36. Else a fourth UTRAN discontinuous reception cycle length may be assigned 34. After assignment of the UTRAN discontinuous reception cycle length, a periodic check 40 is made that the service type may be unchanged. If a change has occurred, the new service type is determined 30, causing a fresh selection of the UTRAN discontinuous reception cycle.

UTRAN DRX cycle length may be selected dependent upon the type of service, for example as shown in Table 1.

TABLE 1

| Type of Packet Switched Service | UTRAN DRX cycle length |
|---|---|
| Packet Data call | 50 milliseconds |
| Video Clip | 100 milliseconds |
| Web-Browsing | 500 milliseconds |
| FTP Sessions | 2 seconds |
| Multi-Broadcast to a specific User | 5 seconds |
| Group | |

In some other embodiments, UTRAN discontinuous reception cycle length for a mobile user terminal may be selected dependent not only on service type to that mobile user terminal but also other service parameters. One example is quality of service (“QoS”) class, where certain classes of mobiles get higher priority. Another example may be proximity to a base station.

Setting CN Discontinuous Reception Cycle Length

The core network (“CN”) domain discontinuous reception cycle length is generally longer than that of the UTRAN discontinuous reception cycle length. The CN discontinuous reception cycle length may be used by the mobile user terminal when the mobile user terminal is in idle mode. That is when it does not have any call connections to the UMTS network 2 (and is, of course, a different mode to URA_PCH mode). All the mobile user terminals in the UMTS network 2 are informed about the discontinuous reception cycle length through the system information broadcast (SIB) which may be a regular broadcast to all mobile user terminals.

As shown in FIG. 7, the CN discontinuous reception cycle length may be set depending on the time of day, for example, a shorter value (e.g., 10 seconds) is used during the daytime and a longer value (e.g., 1 minute) for the early hours of the morning (e.g., 4 am).

During the busiest call activity period (e.g., 4 pm to 6 pm), the CN discontinuous reception cycle length may be set to a shorter value still (e.g., 100 milliseconds).

As shown in FIG. 7, the CN discontinuous reception cycle may be set by a CN discontinuous reception cycle length selection module 42 of the core network 9 which may include an input 44 from a clock 46 so as to inform of the time of day. The RNC 8 is informed of the CN discontinuous reception cycle length.

Setting the CN discontinuous reception cycle length depending on the time of day makes efficient use of the mobile user terminal battery life. This may be because the mobile user terminal effectively wakes up less frequently when it is less likely to receive an incoming call.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. A method of intermittent activation of receiving circuitry of a mobile user terminal to listen to a paging channel, the activation being periodic with a period selected dependent upon either the time of day or which one of a plurality of types of service is provided in the last call connection to the mobile user terminal.

2. A method according to claim 1, wherein the period is selected dependent upon which one of a plurality of types of service is provided in the last call connection to the mobile user terminal.

3. A method according to claim 2, wherein the type of service is indicated in a user profile in respect of the call connection to be made with the mobile user terminal received by the base station from elsewhere in the network.

4. A method according to claim 2, comprising sending in a call connection information of the period to be used after the call connection.

5. A method according to claim 2, wherein the period is for use if the mobile user terminal is in control signalling connection with a base station.

6. A method according to claim 5, wherein the period is for use if the mobile user terminal is in UTRAN Registration Area Paging Channel (“URA_PCH”) mode, the network being a Universal Mobile Telecommunications System (“UMTS”) network.

7. A method according to claim 1, wherein the period is selected dependent upon the time of day.

8. A method according to claim 7, wherein information of the period to be used is sent in a System Information Broadcast (“SIB”).

9. A method according to claim 7, wherein the period is to be used if the mobile user terminal is in idle mode, the network being a Universal Mobile Telecommunications System (UMTS) network.

10. A method according to claim 1, wherein a first period is selected dependent upon which one of a plurality of types of service is provided in the last call connection to the mobile user terminal for use if the mobile user terminal is in one mode, and a second period is selected dependent upon the time of day for use if the mobile user terminal is in another mode.

11. A method according to claim 10, wherein the first mode is URA_PCH mode, and the second mode is idle mode, the network being a Universal Mobile Telecommunications System (UMTS) network.

12. A network for mobile telecommunications comprising a base station and a mobile user terminal, the mobile user terminal comprising receiving circuitry and activation circuitry for intermittent activation of the receiving circuitry so as to listen to a paging channel, the activation being periodic with a period selected dependent upon either the time of day or which one of a plurality of types of service was provided in the last call connection to the mobile user terminal.

13. A network according to claim 12, wherein the period was selected dependent upon which of a plurality of types of service is provided in the last call connection to the mobile user terminal.

14. A network according to claim 13, wherein the type of service is indicated in a user profile received by the base station from elsewhere in the network in respect of the call connection to be made with the mobile user terminal, the base station comprising a selector to select the period dependent upon the type of service indicated.

15. A network according to claim 13, wherein the base station comprises a transmitter operative to send in a call connection information of the period to be used after the call connection, and the mobile user terminal comprises a receiver operative to receive said information.

16. A network according to claim 13, wherein the period is for use if the mobile user terminal is in control signalling connection with a base station.

17. A network according to claim 16, wherein the period is for use if the mobile user terminal is in UTRAN Registration Area Paging Channel (“URA_PCH”) mode, the network being a Universal Mobile Telecommunications System (“UMTS”) network, the base station comprising a base transceiver station and radio network controller (“RNC”).

18. A network according to claim 12, wherein the period is selected dependent upon the time of day.

19. A network according to claim 18, wherein information of the period to be used is sent from the base station to the mobile user terminal in a System Information Broadcast (“SIB”).

20. A network according to claim 18, wherein the period is to be used if the mobile user terminal is in idle mode, the network being a Universal Mobile Telecommunications System (“UMTS”) network.

21. A network according to claim 12, wherein a first period is selected dependent upon which one of a plurality of types of service is provided in the last call connection to the mobile user terminal for use when the mobile user terminal is in one mode, and a second period is selected dependent upon the time of day for use if the mobile user terminal is in another mode.

22. A network according to claim 21, wherein the first mode is URA_PCH mode, and the second mode is idle mode, the network being a Universal Mobile Telecommunications System (“UMTS”) network.

23. A network according to claim 12, wherein the base station comprises a base station controller and at least one base transmitter-receiver station.
